(19) United States
(12) Patent Application Publication
(10) Pub. No.: US 2021/0084521 A1
(43) Pub. Date: Mar. 18, 2021

(54) METHOD AND APPARATUS FOR HANDLING INCOMPATIBLE REQUEST MESSAGE IN MACHINE-TO-MACHINE SYSTEM

(71) Applicants: Hyundai Motor Company, Seoul (KR); Kia Motors Corporation, Seoul (KR)

(72) Inventors: Young Jin Na, Hwaseong (KR); Min Byeong Lee, Hwaseong (KR); Whapyeong Lim, Hwaseong (KR)

(21) Appl. No.: 17/022,794

(22) Filed: Sep. 16, 2020

Related U.S. Application Data
(60) Provisional application No. 62/900,906, filed on Sep. 16, 2019.

(51) Int. Cl. H04W 28/02; H04W 4/70; H04W 8/22; H04W 76/18

(52) U.S. Cl. CPC H04W 28/0215; H04W 76/18; H04W 8/22; H04W 4/70

(57) ABSTRACT

A method and device are configured to handle an incompatible request message in a machine-to-machine (M2M) system. The method is performed by a machine-to-machine (M2M) apparatus in the M2M system, and includes steps of: receiving at least one incompatible request message; processing the incompatible request message according to a message handling policy; and transmitting at least one response message corresponding to the incompatible request message.

### CROSS REFERENCE TO RELATED APPLICATION

The present application claims the benefit of U.S. Provisional Patent Application No. 62/900,906, filed Sep. 16, 2019, the entire contents of which are incorporated by reference herein.

### BACKGROUND

### (a) Technical Field

The present disclosure relates to a method and apparatus for handling at least one incompatible request message in a machine-to-machine system.

### (b) Description of the Related Art

Recently, a Machine-to-Machine (M2M) system has been introduced. An M2M communication refers to a communication executed between machines without human intervention. M2M may refer to Machine Type Communication (MTC), Internet of Things (IoT) or Device-to-Device (D2D). In the following description, the term “M2M” is uniformly used for convenience of explanation, but the present disclosure is not limited thereto. A terminal used for M2M communication may be an M2M terminal or an M2M device. An M2M terminal may generally be a device having low mobility while transmitting a small amount of data. Herein, the M2M terminal may be used in connection with an M2M server that centrally stores and manages inter-machine communication information.

In addition, an M2M terminal may be applied to various systems such as object tracking, automobile linkage, and power metering. Meanwhile, with respect to an M2M terminal, the oneM2M standardization organization provides requirements for M2M communication, things to things communication and IoT technology, and technologies for architecture, Application Program Interface (API) specifications, security solutions and interoperability. The specifications of the oneM2M standardization organization provide a framework to support a variety of applications and services such as smart cities, smart grids, connected cars, home automation, security, and health.

### SUMMARY

The present disclosure provides a method and device for handling an incompatible request message in a machine-to-machine system.

According to the present disclosure, a message handling method performed by a machine-to-machine (M2M) apparatus in an M2M system may include receiving at least one incompatible request message, processing the incompatible request message according to a message handling policy and transmitting at least one response message corresponding to the incompatible request message.

According to the present disclosure, a machine-to-machine (M2M) apparatus in an M2M system may comprise a communication unit configured to transmit and receive a signal and a processor configured to control the communication unit, wherein the processor is configured to process a received incompatible request message according to a message handling policy and transmit at least one response message corresponding to the incompatible request message.

According to the present disclosure, a machine-to-machine (M2M) apparatus in an M2M system may include a communication unit configured to transmit and receive a signal and a processor configured to control the communication unit, wherein the processor is configured to generate an incompatible request message to be transmitted to another M2M apparatus, and check a response status code of a response message received from the other M2M apparatus and corresponding to the incompatible request message, and wherein the response status code is determined based on a message handling policy of the other M2M apparatus.

### BRIEF DESCRIPTION OF THE DRAWINGS

These and/or other aspects of the disclosure will become apparent and more readily appreciated from the following description of the exemplary embodiments, taken in conjunction with the accompanying drawings of which:

FIG. 1 is a view illustrating a layered structure of a Machine-to-Machine (M2M) system according to the present disclosure;

FIG. 2 is a view illustrating reference points in an M2M system according to the present disclosure.

FIG. 3 is a view illustrating a common service function in an M2M system according to the present disclosure.

FIG. 4 is a view illustrating a common service function in an M2M system according to the present disclosure.

FIG. 5 is a view illustrating that an originator and a receiver exchange a message in an M2M system according to the present disclosure.

FIG. 6 is a view showing the case where incompatible request messages are in conflict in an M2M system according to the present disclosure.

FIGS. 7 and 8 are views showing a message handling policy in an M2M system according to the present disclosure.

FIG. 9 is a view showing resources and attributes related to a message handling policy in an M2M system according to the present disclosure.

FIGS. 10 and 11 are views showing a message handling order for each subject in an M2M system according to the present disclosure.

FIGS. 12 and 13 are views showing a scenario in which message handling is required in an M2M system according to the present disclosure.

FIGS. 14 and 15 are views showing a response status code for an incompatible request message in an M2M system according to the present disclosure.

FIGS. 16 and 17 are views illustrating a message handling method in an M2M system according to the present disclosure.

FIG. 18 is a view showing the configuration of an M2M apparatus in an M2M system according to the present disclosure.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings, which will be easily implemented by those skilled in the art. However, the present disclosure may be embodied in many different forms and is not limited to the exemplary embodiments described herein.

In the present disclosure, the terms first, second, etc. are used only for the purpose of distinguishing one component from another, and do not limit the order or importance of components, etc. unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, when a component is referred to as being “linked”, “coupled”, or “connected” to another component, it is understood that not only a direct connection relationship but also an indirect connection relationship through an intermediate component may also be included. Also, when a component is referred to as “comprising” or “having” another component, it may mean further inclusion of another component not the exclusion thereof, unless explicitly described to the contrary.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various exemplary embodiments are not necessarily essential components, and some may be optional components. Accordingly, embodiments consisting of a subset of the components described in one embodiment are also included within the scope of the present disclosure. Also, exemplary embodiments that include other components in addition to the components described in the various embodiments are also included in the scope of the present disclosure.

In the following description of the exemplary embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

In addition, the present specification describes a network based on Machine-to-Machine (M2M) communication, and a task in an M2M communication network may be performed in a process of network control and data transmission in a system managing the communication network.

In the present specification, an M2M terminal may be a terminal performing M2M communication. However, in consideration of backward compatibility, it may be a terminal operating in a wireless communication system. In other words, an M2M terminal may refer to a terminal operating based on M2M communication network but is not limited thereto. An M2M terminal may operate based on another wireless communication network and is not limited to the exemplary embodiment described above.

In addition, an M2M terminal may be fixed or have mobility. The M2M server refers to a server for M2M communication and may be a fixed station or a mobile station.

In the present specification, an entity may refer to hardware such as the M2M device, M2M gateway and M2M server. For example, an entity may be used to refer to software configuration in a layered structure of M2M system and is not limited to the embodiment described above. In addition, for example, the present disclosure mainly describes an M2M system but is not solely applied thereto.

The M2M server may be configured to perform communication with an M2M terminal or another M2M server. In addition, an M2M gateway may be a connection point between an M2M terminal and an M2M server. For example, when an M2M terminal and an M2M server have different networks, the M2M terminal and the M2M server may be connected to each other via an M2M gateway. Herein, for example, both an M2M gateway and an M2M server may be M2M terminals and are not limited to the exemplary embodiment described above.

Further, in the present disclosure, storage may include a database. Sensitive data may be used to refer to private data and personal data. Additionally, in the present disclosure, an M2M terminal may be used interchangeably with M2M apparatus and M2M device. A communication unit may be used interchangeably with a communication unit.

Additionally, oneM2M is a de facto standards organization that was founded to develop a communal IoT service platform sharing and integrating application service infrastructure (platform) environments beyond fragmented service platform development structures limited to separate industries like energy, transportation, national defense and public service.oneM2M aims to render requirements for things to things communication and IoT technology, architectures, Application Program Interface (API) specifications, security solutions and interoperability. For example, the specifications of oneM2M provide a framework to support a variety of applications and services such as smart cities, smart grids, connected vehicles, home automation, security and health. In this regard, oneM2M has developed a set of standards defining a single horizontal platform for data exchange and sharing among all the applications.

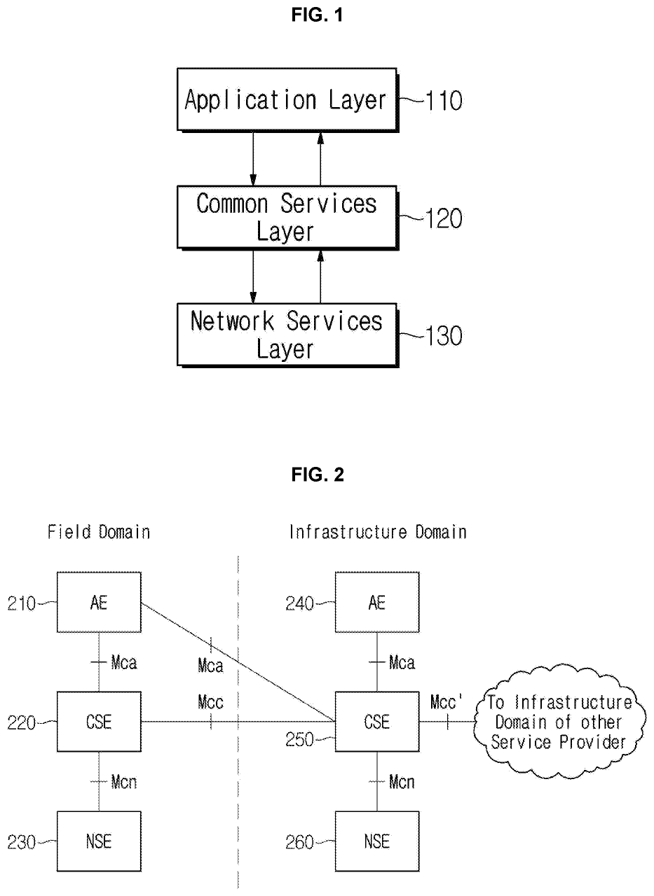

Applications across different industrial sections may also be considered by oneM2M. Similar to an operating system, oneM2M provides a framework connecting different technologies, thereby creating distributed software layers facilitating unification. Distributed software layers are implemented in a common services layer between M2M applications and communication Hardware/Software (HW/SW) rendering data transmission. For example, a common services layer may be a part of a layered structure illustrated in FIG. 1.

FIG. 1 is a view illustrating a layered structure of a Machine-to-Machine (M2M) system according to the present disclosure. Referring to FIG. 1, a layered structure of an M2M system may include an application layer 110, a common services layer 120 and a network services layer 130. Herein, the application layer 110 may be a layer that operates based on a specific application. For example, an application may be a fleet tracking application, a remote blood sugar monitoring application, a power metering application or a controlling application. In other words, an application layer may a layer for a specific application. Herein, an entity operating based on an application layer may be an application entity (AE).

The common services layer 120 may be a layer for a common service function (CSF). For example, the common services layer 120 may be a layer configured to provide common services like data management, device management, M2M service subscription management and location service. For example, an entity operating based on the common services layer 120 may be a common service entity (CSE). The common services layer 120 may be configured to provide a set of services that are grouped into CSFs according to functions. A multiplicity of instantiated CSFs constitutes CSEs. CSEs may interface with applications (e.g., application entities or AEs in the terminology of oneM2M), other CSEs and base networks (for example, network service entities or NSEs in the terminology of oneM2M).

The network services layer 130 may be configured to provide the common services layer 120 with services such as device management, location service, and device triggering. Herein, an entity operating based on the network layer 120 may be a network service entity (NSE).

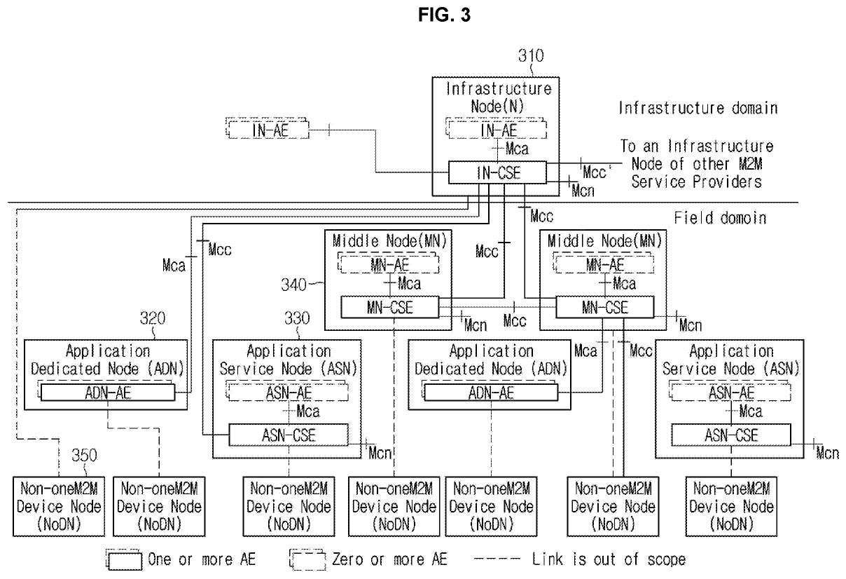

FIG. 2 is a view illustrating reference points in an M2M system according to the present disclosure. Referring to FIG. 2, an M2M system structure may be distinguished into a field domain and an infrastructure domain. Herein, in each domain, each of the entities may be configured to perform communication via a reference point (e.g., Mca or Mcc). For example, a reference point may indicate a communication flow between each entity. In particular, referring to FIG. 2, the reference point Mca between AE 210 or 240 and CSE 220 or 250, the reference point Mcc between different CSEs and Mcn reference point between CSE 220 or 250 and NSE 230 or 260 may be set.

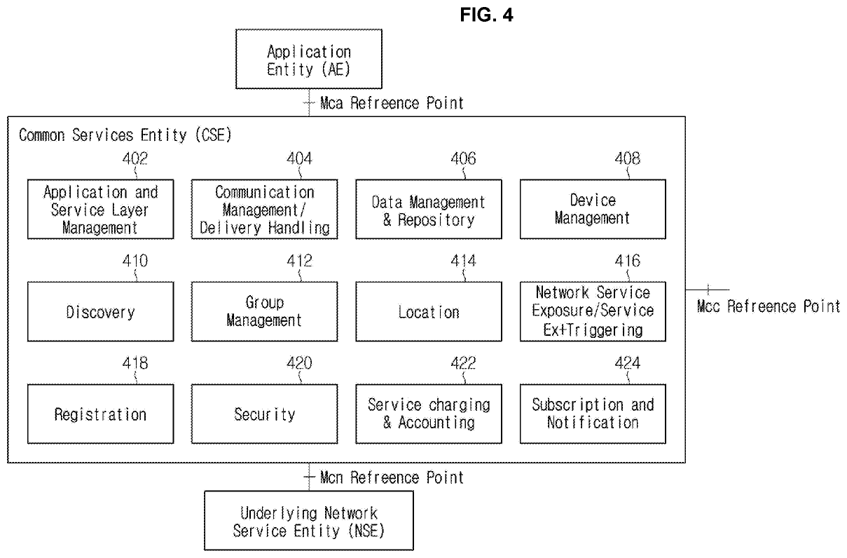

FIG. 3 is a view illustrating each node in an M2M system according to the present disclosure. Referring to FIG. 3, an infrastructure domain of a specific M2M service provider may be configured to provide a specific infrastructure node (IN) 310. Herein, the CSE of the IN may be configured to perform communication based on the AE and the reference point Mca of another infrastructure node. In particular, one IN may be set for each M2M service provider. In other words, the IN may be a node configured to perform communication with the M2M terminal of another infrastructure based on an infrastructure structure. In addition, for example, conceptually, a node may be a logical entity or a software configuration.

Furthermore, an application dedicated node (ADN) 320 may be a node including at least one AE but not CSE. Particularly, an ADN may be set in the field domain. In other words, an ADN may be a dedicated node for AE. For example, an ADN may be a node that is set in an M2M terminal in hardware. In addition, the application service node (ASN) 330 may be a node including one CSE and at least one AE. ASN may be set in the field domain. In other words, it may be a node including AE and CSE. In particular, an ASN may be a node connected to an IN. For example, an ASN may be a node that is set in an M2M terminal in hardware.

In addition, a middle node (MN) 340 may be a node including a CSE and including zero or more AEs. Particularly, the MN may be set in the field domain. An MN may be connected to another MN or IN based on a reference point. In addition, for example, an MN may be set in an M2M gateway in hardware. In addition, as an example, a non-M2M terminal node 350 (Non-M2M device node, NoDN) is a node that does not include M2M entities. It may be a node that performs management or collaboration together with an M2M system.

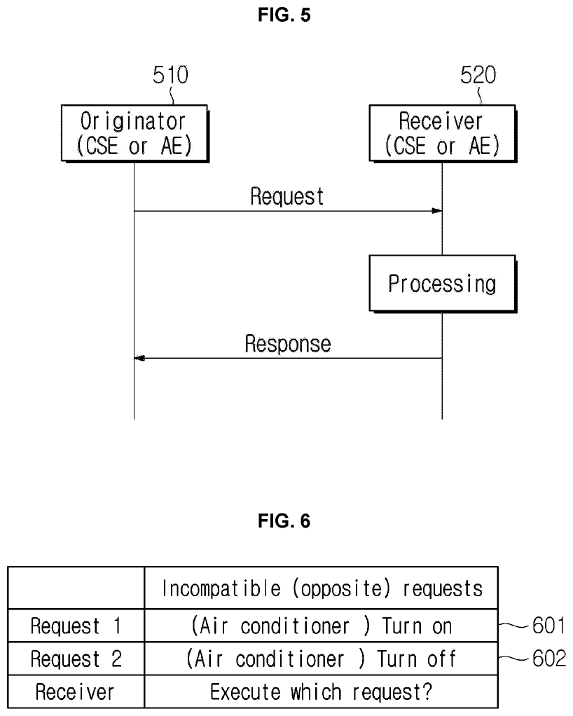

FIG. 4 is a view illustrating a common service function in an M2M system according to the present disclosure. Referring to FIG. 4, common service functions may be provided. For example, a common service entity may be configured to provide at least one or more CSFs among application and service layer management 402, communication management and delivery handling 404, data management and repository 406, device management 408, discovery 410, group management 412, location 414, network service exposure/service execution and triggering 416, registration 418, security 420, service charging and accounting 422, service session management and subscription/notification 424. At this time, M2M terminals may be configured to operate based on a common service function. In addition, a common service function may be possible in other exemplary embodiments and is not limited to the above-described exemplary embodiment.

The application and service layer management 402 CSF may be configured to provide management of AEs and CSEs. The application and service layer management 402 CSF may include the configuring, problem solving and upgrading of CSE functions and the capability of upgrading AEs. The communication management and delivery handling 404 CSF may be configured to provide communications with other CSEs, AEs and NSEs. The communication management and delivery handling 404 CSF may be configured to determine at what time and through what connection communications are to be delivered, and determine to buffer communication requests to thus deliver the communications delivered later, if necessary and permitted.

The data management and repository 406 CSF may be configured to provide data storage and transmission functions (e.g., data collection for aggregation, data reformatting, and data storage for analysis and sematic processing). The device management 408 CSF may be configured to provide the management of device capabilities in M2M gateways and M2M devices. The discovery 410 CSF may be configured to provide an information retrieval function for applications and services based on filter criteria.

The group management 412 CSF may be configured to provide processing of group-related requests. The group management 412 CSF enables an M2M system to support bulk operations for many devices and applications. The location 414 CSF may be configured to enable AEs to obtain geographical location information. The network service exposure/service execution and triggering 416 CSF may be configured to manage communications with base networks for access to network service functions.

The registration 418 CSF may be configured to register AEs (or other remote CSEs) to a CSE. The registration 418 CSF allows AEs (or remote CSE) to use services of CSE. The security 420 CSF may be configured to provide a service layer with security functions like access control including identification, authentication and permission. The service charging and accounting 422 CSF may be configured to provide charging functions for a service layer. The subscription/notification 424 CSF may be configured to provide a function of allowing subscription to an event and notifying the occurrence of the event.

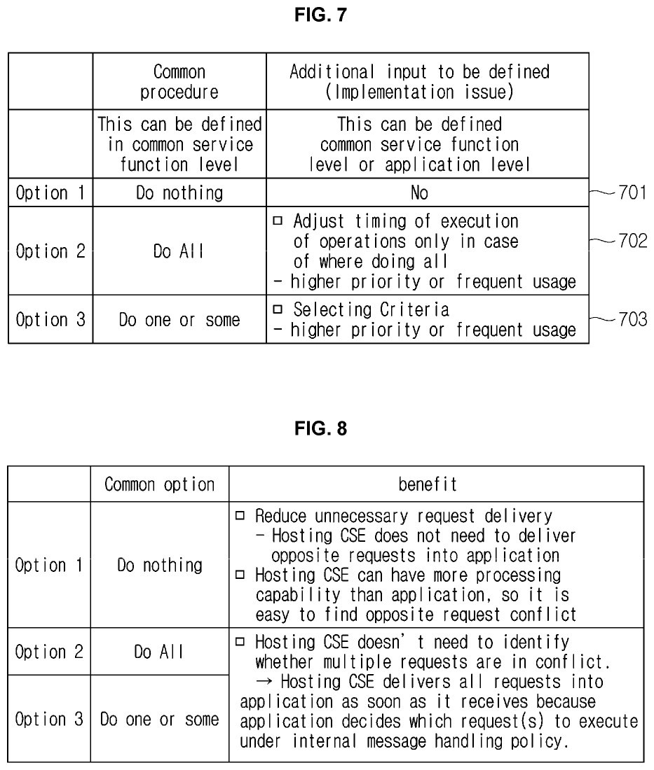

FIG. 5 is a view illustrating that an originator and a receiver exchange a message in an M2M system according to the present disclosure. Referring to FIG. 5, the originator 501 may be configured to transmit a request message to the receiver 520. In particular, the originator 510 and the receiver 520 may be the above-described M2M terminals. However, the originator 510 and the receiver 520 are not limited to M2M terminals but may be other terminals. They are not limited to the above-described exemplary embodiment. In addition, for example, the originator 510 and the receiver 520 may be nodes, entities, servers or gateways, which are described above. In other words, the originator 510 and the receiver 520 may be hardware or software configurations and are not limited to the above-described exemplary embodiment.

Additionally, a request message transmitted by the originator 510 may include at least one parameter. Herein, for example, a parameter may be a mandatory parameter or an optional parameter. For example, a parameter related to a transmission terminal, a parameter related to a receiving terminal, an identification parameter and an operation parameter may be mandatory parameters. In addition, optional parameters may be related to other types of information. In particular, a transmission terminal-related parameter may be a parameter for the originator 510. A receiving terminal-related parameter may be a parameter for the receiver 520. An identification parameter may be a parameter required for identification of each other.

An operation parameter may be a parameter for distinguishing operations. For example, an operation parameter may be set to any one among Create, Retrieve, Update, Delete and Notify. In other words, the parameter may aim to distinguish operations. Particularly, in response to receiving a request message from the originator 510, the receiver 520 may be configured to process the message. For example, the receiver 520 may be configured to perform an operation included in a request message. For the operation, the receiver 520 may be configured to determine whether a parameter is valid and authorized. In particular, if a parameter is valid and authorized, the receiver 520 may be configured to check whether there is a requested resource and may perform processing accordingly.

For example, when an event occurs, the originator 510 may be configured transmit a request message including a parameter for notification to the receiver 520. The receiver 520 may be configured to check a parameter for a notification included in a request message and perform an operation accordingly. The receiver 520 may be configured to transmit a response message to the originator 510.

A message exchange process using a request message and a response message, as illustrated in FIG. 5, may be performed between AE and CSE based on the reference point Mca or between CSEs based on the reference point Mcc. In other words, the originator 510 may be AE or CSE, and the receiver 520 may be AE or CSE. According to an operation in a request message, such a message exchange process as illustrated in FIG. 5 may be initiated by either AE or CSE.

A request from a requestor to a receiver through the reference points Mca and Mcc may include at least one mandatory parameter and at least one optional parameter. In other words, each defined parameter may be either mandatory or optional according to a requested operation. For example, a response message may include at least one parameter among those listed in Table 1 below.

TABLE 1
Response message parameter/success or not

Response Status Code-successful, unsuccessful, ack
Request Identifier-uniquely identifies a Request message
Content-to be transferred
To-the identifier of the Originator or the Transit CSE that sent the
corresponding non-blocking request
From-the identifier of the Receiver
Originating Timestamp-when the message was built
Result Expiration Timestamp-when the message expires
Event Category-what event category shall be used for the response
message
Content Status
Content Offset
Token Request Information
Assigned Token Identifiers
Authorization Signature Request Information
Release Version Indicator-the oneM2M release version that this
response message conforms to

A filter criteria condition, which can be used in a request message or a response message, may be defined as in Table 2 and Table 3 below.

TABLE 2

| | | |
|---|---|---|
| Condition | Multi- | |
| tag | plicity | Description |

Matching Conditions

| | | |
|---|---|---|
| createdBefore | 0 . . . 1 | The creationTime attribute of the matched resource is chronologically |
| | | before the specified value. |
| createdAfter | 0 . . . 1 | The creationTime attribute of the matched resource is chronologically |
| | | after the specified value. |
| modifiedSince | 0 . . . 1 | The lastModifiedTime attribute of the matched resource is |
| | | chronologically after the specified value. |
| unmodifiedSince | 0 . . . 1 | The lastModifiedTime attribute of the matched resource is |
| | | chronologically before the specified value. |
| stateTagSmaller | 0 . . . 1 | The stateTag attribute of the matched resource is smaller than the |
| | | specified value. |
| stateTagBigger | 0 . . . 1 | The stateTag attribute of the matched resource is bigger than the |
| | | specified value. |
| expireBefore | 0 . . . 1 | The expirationTime attribute of the matched resource is chronologically |
| | | before the specified value. |
| expireAfter | 0 . . . 1 | The expirationTime attribute of the matched resource is chronologically |
| | | after the specified value. |
| labels | 0 . . . 1 | The labels attribute of the matched resource matches the specified value. |
| labelsQuery | 0 . . . 1 | The value is an expression for the filtering of labels attribute of resource |
| | | when it is of key-value pair format. The expression is about the |
| | | relationship between label-key and label-value which may include equal |
| | | to or not equal to. within or not within a specified set etc. For example, |
| | | label-key equals to label value, or label-key within {label-value1, label- |
| | | value2}. Details are defined in [3] |
| childLabels | 0 . . . 1 | A child of the matched resource has labels attributes matching the |
| | | specified value. The evaluation is the same as for the labels attribute |
| | | above. Details are defined in [3]. |
| parentLabels | 0 . . . 1 | The parent of the matched resource has labels attributes matching the |
| | | specified value. The evaluation is the same as for the labels attribute |
| | | above. Details are defined in [3]. |
| resourceType | 0 . . . n | The resourceType attribute of the matched resource is the same as the |
| | | specified value. It also allows differentiating between normal and |
| | | announced resources. |
| childResourceType | 0 . . . n | A child of the matched resource has the resourceType attribute the same |
| | | as the specified value. |
| parentResourceType | 0 . . . 1 | the parent of the matched resource has the resourceType attribute the |
| | | same as the specified value. |
| sizeAbove | 0 . . . 1 | The contentSize attribute of the <contentInstance> matched resource is |
| | | equal to or greater than the specified value. |
| sizeBelow | 0 . . . 1 | The contentSize attribute of the <contentInstance> matched resource is |
| | | smaller than the specified value. |
| contentType | 0 . . . n | The contentInfo attribute of the <contentInstance> matched resource |
| | | matches the specified value. |
| attribute | 0 . . . n | This is an attribute of resource types (clause 9.6). Therefore, a real tag |
| | | name is variable and depends on its usage and the value of the attribute |
| | | can have wild card *. E.g. creator of container resource type can be used |
| | | as a filter criteria tag as ″creator = Sam″, ″creator = Sam*″, |
| | | ″creator = *Sam″. |
| childAttribute | 0 . . . n | A child of the matched resource meets the condition provided. The |
| | | evaluation of this condition is similar to the attribute matching condition |
| | | above. |
| parent Attribute | 0 . . . n | The parent of the matched resource meets the condition provided. The |
| | | evaluation of this condition is similar to the attribute matching condition |
| | | above. |
| semanticsFilter | 0 . . . n | Both semantic resource discovery and semantic query use |
| | | semanticsFilter to specify a query statement that shall be specified in the |
| | | SPARQL query language [5]. When a CSE receives a RETRIEVE |
| | | request including a semanticsFilter, and the Semantic Query Indicator |
| | | parameter is also present in the request, the request shall be processed |
| | | as a semantic query; otherwise, the request shall be processed as a |
| | | semantic resource discovery. |
| | | In the case of semantic resource discovery targeting a specific resource, |
| | | if the semantic description contained in the <semanticDescriptor> of a |
| | | child resource matches the semanticFilter, the URI of this child resource |
| | | will be included in the semantic resource discovery result. |
| | | In the case of semantic query, given a received semantic query request |
| | | and its query scope, the SPARQL query statement shall be executed |
| | | over aggregated semantic information collected from the semantic |
| | | resource(s) in the query scope and the produced output will be the result |
| | | of this semantic query. |
| | | Examples for matching semantic filters in SPARQL to semantic |
| | | descriptions can be found in [i.28]. |
| filterOperation | 0 . . . 1 | Indicates the logical operation (AND/OR) to be used for different |
| | | condition tags. The default value is logical AND. |
| contentFilterSyntax | 0 . . . 1 | Indicates the Identifier for syntax to be applied for content-based |
| | | discovery. |
| contentFilterQuery | 0 . . . 1 | The query string shall be specified when contentFilterSyntax parameter |
| | | is present. |

TABLE 3

| | | |
|---|---|---|
| Condition | Multi- | |
| tag | plicity | Description |

Filter Handling Conditions

| | | |
|---|---|---|
| filterUsage | 0 . . . 1 | Indicates how the filter criteria is used. If provided, possible values are |
| | | ′discovery′ and ′IPEOnDemandDiscovery′. |
| | | If this parameter is not provided, the Retrieve operation is a generic |
| | | retrieve operation and the content of the child resources fitting the filter |
| | | criteria is returned. |
| | | If filterUsage is ′discovery′, the Retrieve operation is for resource |
| | | discovery (clause 10.2.6), i.e. only the addresses of the child resources |
| | | are returned. |
| | | If filterUsage is ′IPEOnDemandDiscovery′, the other filter conditions are |
| | | sent to IPE as well as the discovery Originator ID. When the IPE |
| | | successfully generates new resources matching with the conditions, then |
| | | the resource address(es) shall be returned. This value shall only be valid |
| | | for the Retrieve request targeting an <AE> resource that represents the |
| | | IPE. |
| limit | 0 . . . 1 | The maximum number of resources to be included in the filtering result. |
| | | This may be modified by the Hosting CSE. When it is modified, then the |
| | | new value shall be smaller than the suggested value by the Originator. |
| level | 0 . . . 1 | The maximum level of resource tree that the Hosting CSE shall perform |
| | | the operation starting from the target resource (i.e. To parameter). This |
| | | shall only be applied for Retrieve operation. The level of the target |
| | | resource itself is zero and the level of the direct children of the target is one. |
| offset | 0 . . . 1 | The number of direct child and descendant resources that a Hosting CSE |
| | | shall skip over and not include within a Retrieve response when |
| | | processing a Retrieve request to a targeted resource. |
| applyRelativePath | 0 . . . 1 | This attribute contains a resource tree relative path |
| | | (e.g. ../tempContainer/LATEST). This condition applies after all the |
| | | matching conditions have been used (i.e. a matching result has been |
| | | obtained). The attribute determines the set of resource(s) in the final |
| | | filtering result. The filtering result is computed by appending the relative |
| | | path to the path(s) in the matching result. All resources whose Resource- |
| | | IDs match that combined path(s) shall be returned in the filtering result. |
| | | If the relative path does not represent a valid resource, the outcome is the |
| | | same as if no match w as found, i.e. there is no corresponding entry in the |
| | | filtering result. |

A response to a request for accessing a resource through the reference points Mca and Mcc may include at least one mandatory parameter and at least one optional parameter. In other words, each defined parameter may be either mandatory or optional according to a requested operation or a mandatory response code. For example, a request message may include at least one parameter among those listed in Table 4 below.

TABLE 4
Request message parameter

| | |
|---|---|
| Mandatory | Operation-operation to be executed/CREAT, Retrieve, Update, Delete, Notify |
| | To-the address of the target resource on the target CSE |
| | From-the identifier of the message Originator |
| | Request Identifier-uniquely identifies a Request message |
| Operation | Content-to be transferred |
| dependent | Resource Type-of resource to be created |
| Optional | Originating Timestamp-when the message was built |
| | Request Expiration Timestamp-when the request message expires |
| | Result Expiration Timestamp-when the result message expires |
| | Operational Execution Time-the time when the specified operation is to be executed by |
| | the target CSE |
| | Response Type-type of response that shall be sent to the Originator |
| | Result Persistence-the duration for which the reference containing the responses is to |
| | persist |
| | Result Content-the expected components of the result |
| | Event Category-indicates how and when the system should deliver the message |
| | Delivery Aggregation-aggregation of requests to the same target CSE is to be used |
| | Group Request Identifier-Identifier added to the group request that is to be fanned out to |
| | each member of the group |
| | Group Request Target Members-indicates subset of members of a group |
| | Filter Criteria-conditions for filtered retrieve operation |
| | Desired Identifier Result Type-format of resource identifiers returned |
| | Token Request Indicator-indicating that the Originator may attempt Token Request |
| | procedure (for Dynamic Authorization) if initiated by the Receiver |
| | Tokens-for use in dynamic authorization |
| | Token IDs-for use in dynamic authorization |
| | Role IDs-for use in role based access control |
| | Local Token IDs-for use in dynamic authorization |
| | Authorization Signature Indicator-for use in Authorization Relationship Mapping |
| | Authorization Signature-for use in Authorization Relationship Mapping |
| | Authorization Relationship Indicator-for use in Authorization Relationship Mapping |
| | Semantic Query Indicator-for use in semantic queries |
| | Release Version Indicator-the oneM2M release version that this request message |
| | conforms to. |
| | Vendor Information |

A normal resource includes a complete set of representations of data forming the base of information to be managed. Unless qualified as either “virtual” or “announced”, the resource types in the present document are normal resources. A virtual resource is used to trigger processing and/or a retrieve result. However, a virtual resource does not have a permanent representation in a CSE.

An announced resource contains a set of attributes of an original resource. When an original resource changes, an announced resource is automatically updated by the hosting CSE of the original resource. The announced resource contains a link to the original resource. Resource announcement enables resource discovery. An announced resource at a remote CSE may be used to generate a child resource at a remote CSE, which is not present as a child of an original resource or is not an announced child thereof.

To support resource announcement, an additional column in a resource template may specify attributes to be announced for inclusion in an associated announced resource type. For each announced <resourceType>, the addition of suffix “Annc” to the original <resourceType> may be used to indicate its associated announced resource type. For example, resource <containerAnnc> may indicate the announced resource type for <container> resource, and <groupAnnc> may indicate the announced resource type for <group> resource.

Resources may be specified in associated to CSE. Resources are representation of component and element in CSE at oneM2M system. Other CSEs, AEs, application data for sensor and commands are notified to CSE as an indication of resource representation. A resource is an entity that is uniquely addressable in oneM2M architecture. Resource is delivered and may be manipulated by CRUD (Create Retrieve Update Delete) operation.

A child resource is a sub-resource of the parent resource. The parent resource may include the reference to at least one child resource. An attribute may contain the information of resource. The set of attributes is not listed within the graphical representation of the resource, unless common to all resources. An attribute may be distinguished as universal attribute, common attribute and resource-specific attribute. The universal attribute is an attribute that appears on all resources. The common attribute is an attribute that appears on multiple resources and has the same meaning wherever it appears.

Table 5 may show the examples of the attributes that are virtual or not announced, general and universal on all resources.

TABLE 5

| Attribute Name | Description |
|---|---|
| resourceType | Resource Type. This Read Only (assigned at creation time, and then |
| | cannot be changed) attribute identifies the type of the resource as |
| | specified in clause 9.6. Each resource shall have a resourceType |
| | attribute. |
| resourceID | This attribute is an identifier for the resource that is used for ′non- |
| | hierarchical addressing method′, i.e. this attribute shall contain the |
| | ′Unstructured-CSE-relative-Resource-ID′ format of a resource ID as |
| | defined in table 7.2-1. This attribute shall be provided by the Hosting |
| | CSE when it accepts a resource creation procedure. The Hosting CSE |
| | shall assign a resourceID which is unique in that CSE. |
| resourceName | This attribute is the name for the resource that is used for ′hierarchical |
| | addressing method′ to represent the parent-child relationships of |
| | resources. See clause 7.2 for more details. This attribute may be provided |
| | by the resource creator. The Hosting CSE shall use a provided |
| | resourceName as long as it does not already exist among child resources |
| | of the targeted parent resource. If the resourceName already exists, the |
| | Hosting CSE shall reject the request and return an error to the Originator. |
| | The Hosting CSE shall assign a resourceName if one is not provided by |
| | the resource creator. |
| parentID | This attribute is the resourceID of the parent of this resource. The value |
| | of this attribute shall be NULL for the <CSEBase> resource type. |
| creationTime | Time/date of creation of the resource. This attribute is mandatory for all |
| | resources and the value is assigned by the system at the time when the |
| | resource is locally created. Such an attribute cannot be changed. |
| lastModifiedTime | Last modification time/date of the resource. The lastModifiedTime value |
| | is set by the Hosting CSE when the resource is created, and the |
| | lastModifiedTime value is updated when the resource is updated. |

Table 6 shows examples of attributes that are commonly used in a plurality of resource types (but, not all resource types) that are virtual or not announced.

TABLE 6

| Attribute Name | Description |
|---|---|
| accessControlPolicyIDs | The attribute contains a list of identifiers for <accessControlPolicy> |
| | resources. The privileges defined in the <accessControlPolicy> resources |
| | that are referenced determine who is allowed to access the resource |
| | containing this attribute for a specific purpose (e.g. Retrieve, Update. |
| | Delete, etc.). |
| | For an Update or Delete operation to a resource, the update or delete of the |
| | accessControlPolicyIDs attribute, if applicable, shall be performed prior to |
| | the update or delete of any other attributes of the resource. |
| | To update this attribute, a Hosting CSE shall check whether an Originator |
| | has Update privilege in any selfPrivileges, regardless of privileges, of the |
| | <accessControlPolicy> resources which this attribute originally |
| | references. |
| | After successful update of the accessControlPolicyIDs attribute, resource |
| | access checking for other attributes to be updated shall use the new |
| | privileges defined in the <accessControlPolicy> resource(s) that are |
| | referenced by the newly updated accessControlPolicyIDs attribute. |
| | Similarly, to delete this attribute, a Hosting CSE shall check whether an |
| | Originator has Updateprivilege in any selfPrivileges, regardless of |
| | privileges, of the <accessControlPolicy> resources which this attribute |
| | originally references. |
| | After successful deletion of the accessControlPolicyIDs attribute, resource |
| | access checking for other attributes to be deleted shall use the default |
| | access privileges as described in the following paragraphs. |
| | If a resource type does not have an accessControlPolicyIDs attribute |
| | definition, then the accessControlPolicyIDs for that resource is governed |
| | in a different way, for example, the accessControlPolicy associated with |
| | the parent may apply to a child resource that does not have an |
| | accessControlPolicyIDs attribute definition, or the privileges for access are |
| | fixed by the system. Refer to the corresponding resource type definitions |
| | and procedures to see how access control is handled in such cases. |
| | If a resource type does have an accessControlPolicyIDs attribute |
| | definition, but the (optional) accessControlPolicyIDs attribute value is not |
| | set in a resource instance, then the Hosting CSE shall apply the concept of |
| | the default access policy. The default policy shall provide unrestricted |
| | access only to the Originator of the successful resource creation request. |
| | All other entities shall be denied to access the resource. For that purpose, |
| | the Hosting CSE shall keep that Originator information of the resource. |
| | Note that how to keep that information is implementation specific. The |
| | default access policy is not applied to a resource which has a value |
| | assigned to the accessControlPolicyIDs attribute. |
| | All resources are accessible if and only if the privileges (i.e. configured as |
| | privileges or selfPrivileges attribute of <accessControlPolicy> resource) |
| | allow it, therefore all resources shall have an associated |
| | accessControlPolicyIDs attribute, either explicitly (setting the attribute in |
| | the resource itself) or implicitly (either by using the parent privileges or |
| | the system default policies). Which means that the system shall provide |
| | default access privileges in case that the Originator does not provide a |
| | specific accessControlPolicyIDs during the creation of the resource. |
| expirationTime | Time date after which the resource will be deleted by the Hosting CSE. |
| | This attribute can be provided by the Originator, and in such a case it will |
| | be regarded as a hint to the Hosting CSE on the lifetime of the resource. |
| | The Hosting CSE shall configure the expirationTime value. If the Hosting |
| | CSE configures the new expirationTime attribute value rather than the |
| | Originator suggested value, the new value can be sent back to the |
| | Originator depending on the Result Content value. The lifetime of the |
| | resource can be extended by providing a new value for this attribute in an |
| | UPDATE operation. Or by deleting the attribute value, e.g. by updating |
| | the attribute with NULL when doing a full UPDATE, in which case the |
| | Hosting CSE can decide on a new value. |
| | If the Originator does not provide a value in the CREATE operation the |
| | system shall assign an appropriate value depending on its local policies |
| | and/or M2M service subscription agreements. |
| | A resource is known as ′obsolete′ when the resource contains the attribute |
| | ″expirationTime″and the lifetime of this resource has reached the value of |
| | this attribute. If the ′obsolete′ resource had a reference to an Application |
| | Entity Resource ID. the Hosting CSE shall send a NOTIFY request to the |
| | IN-CSE, requesting to delete the entry from the <AEContactList> |
| | resource. |
| stateTag | An incremental counter of modification on the resource. When a resource |
| | is created, this counter is set to 0, and it will be incremented on every |
| | modification of the resource (see notes 1 and 2). |
| announceTo | This attribute may be included in a CREATE or UPDATE Request in |
| | which case it contains a list of addresses CSE-IDs where the resource is to |
| | be announced. For the case that CSE-IDs are provided, the announced-to |
| | CSE shall decide the location of the announced resources based on the |
| | rules described in clause 9.6.26. For the original resource, this attribute |
| | shall only be present if it has been successfully announced to other CSEs. |
| | This attribute maintains the list of the resource addresses to the |
| | successfully announced resources. Updates on this attribute will trigger |
| | new resource announcement or de-announcement. |
| | If announceTo attribute includes resource address(s), the present |
| | document does not provide any means for validating these address(s) for |
| | announcement purposes. It is the responsibility of the Hosting-CSE |
| | referenced by the resource address(s) to validate the access privileges of |
| | the originator of the Request that triggers the announcement. |
| announcedAttribute | This attributes shall only be present at the original resource if some |
| | Optional Announced (OA) type attributes have been announced to other |
| | CSEs. This attribute maintains the list of the announced Optional |
| | Attributes (OA type attributes) in the original resource. Updates to this |
| | attribute will trigger new attribute announcement if a new attribute is added |
| | or de-announcement if the existing attribute is removed. |
| labels | Tokens used to add meta-information to resources. This attribute is |
| | optional. |
| | The value of the labels attribute is a list of individual labels, each of them |
| | being: |
| | Either a standalone label-key. used as a simple ″tag″, that can be |
| | used for example for discovery purposes when looking for particular |
| | resources that one can ″tag″ using that label-key |
| | Or a composite element made of a label-key and a label-value, |
| | separated by a special character defined in [3]. |
| | The list of allowed characters in a label (and in label-keys and label-values) |
| | and separator characters is defined in [3], clause 6.3.3. |
| e2eSecInfo | Present in a resource representing an AE or CSE. Indicates the end-to-end |
| | security capabilities supported by the AE or CSE. May indicate supported |
| | end-to-end security frameworks. May also contains a certificate or |
| | credential identifier used by the AE or CSE. May include random values |
| | for use in end-to-end security protocols. The details of this attributes are |
| | described in oneM2M TS-0003 [2]. This attribute is optional and if not |
| | present it means that the represented entity does not support oneM2M end- |
| | to-end security procedures. |
| DynamicAuthorization- | This attribute contains a list of identifiers of |
| ConsultationIDs | <dynamicAuthorizationConsultation> resources. The information defined |
| | in a <dynamicAuthorizationConsultation> resource is used by a CSE for |
| | initiating consultation-based dynamic authorization requests. |
| | Consultation-based dynamic authorization is only performed for a targeted |
| | resource if and only if it is linked to an enabled |
| | <dynamicAuthorizationConsultation> resource. |
| | If the attribute is not set or has a value that does not correspond to a valid |
| | <dynamicAuthorizationConsultation> resource(s), or it refers to an |
| | <dynamicAuthorizationConsultation> resource(s) that is not reachable, |
| | then the dynamicAuthorizationConsultationIDs associated with the parent |
| | may apply to the child resource if present, or a system default |
| | <dynamicAuthoriz.ationConsultation> may apply if present. |

According to the present disclosure, when at least one request message is received in an M2M system, a message may be efficiently handled based on the above-described resources and attributes newly defined below.

Hereinafter, prior to describing in more detail with respect to the drawings, in the following description of an embodiment of the present disclosure, an originator and a receiver may respectively mean a transmitter and a receiver and may be an M2M entity including an M2M apparatus and an M2M node. The M2M entity has been defined as described above.

In addition, according to the present disclosure, a request message may be expressed as an incompatible request message. More specifically, the incompatible request message may mean each of a plurality of request messages which are in conflict with each other, and mean a request message having indicated thereby a request service which does not need to be executed (e.g., when the same service as a current M2M state is requested) even based on a single request message.

In addition, a request message in which an incorrect request condition is set or a request message which cannot be executed due to a conflict with the current state of a receiver may be expressed as an incompatible request message.

Accordingly, the following description of the request message is also applicable to the incompatible request message.

Meanwhile, in the above case, an example of the incompatible request message has been described, but it not limited thereto.

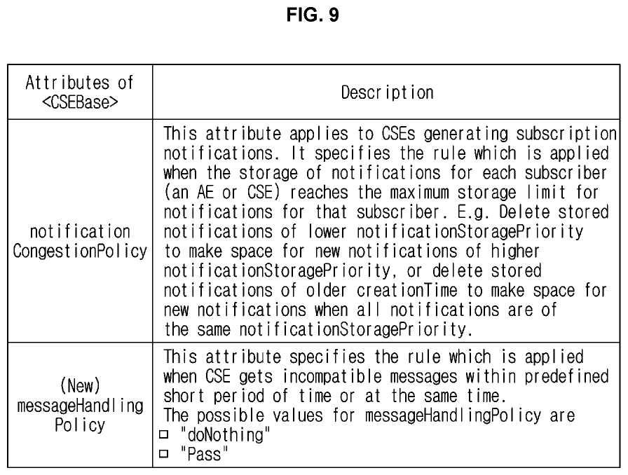

FIG. 6 is a view showing the case where incompatible request messages are in conflict in an M2M system according to the present disclosure.

More specifically, as an embodiment, the case where request messages are incompatible, that is, an incompatible request message is received, when at least one request message transmitted by an originator is received by one receiver is shown.

As an embodiment, different originators may transmit request messages 601 and 602 to a receiver at the same time or at a very short time frame interval. At this time, the very short time frame interval may mean a predetermined period of time. In this case, the receiver may handle, that is, process, the received one or more request messages 601 and 602. In this case, the request messages 601 and 602 may be in conflict with each other, that is, may be incompatible with each other. For example, the request message 601 may request to turn on an air conditioner and the other request message may request to turn off the same air conditioner. When services which are in conflict with each other are requested, the receiver may determine which service is executed or which service is not executed and transmit, to the originators, response messages appropriate to the request messages.

In addition, in addition to the case where the plurality of request messages is in conflict as shown in FIG. 6, in the case where it is unnecessary to execute a request service indicated by a request message (e.g., when the same service as a current M2M state is requested) even based on a single request message, in the case where an incorrect request condition is set in a request message itself or in the case where a request message cannot be executed due to a conflict with the current state of the receiver, the receiver determine which service is executed and which service is not executed and transmit a response message. In the above case, the request message may be expressed as an incompatible request message.

In this case, the receiver may be provided with an appropriate message handling policy. Meanwhile, a current oneM2M does not explicitly define a message handling policy on a message conflict. In a method of handling request messages which are in conflict with each other, the message handling policy is individually at an application level and message processing is somewhat inefficient.

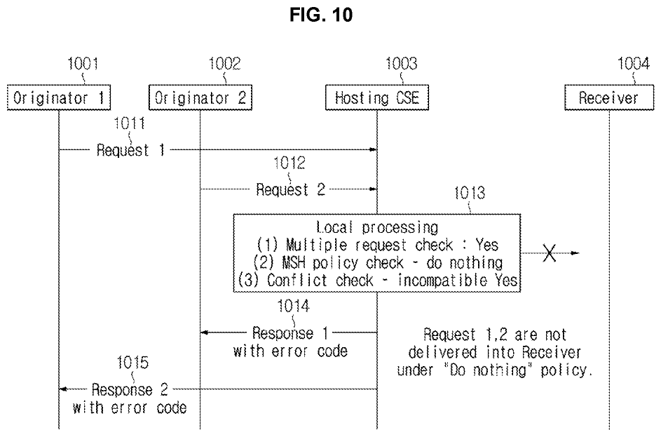

Therefore, hereinafter, a message handling policy generally applicable to various use cases will be described with reference to FIGS. 7 to 18 and a method and apparatus for handling a message based on a message handling policy will be described.

FIGS. 7 and 8 are views showing a message handling policy in an M2M system according to the present disclosure. More specifically, views illustrating a message handling policy for processing an incompatible request message are shown.

In an M2M system, when a receiver receives at least one incompatible request message, the message handling policy may indicate that the receiver rejects execution of services for all request messages (701), executes the services for all the request messages (702) or executes some of the services for all the request messages (703). In this case, the message handling policy may be defined at a common service function (CSF) level.

As an embodiment, when the receiver rejects execution of the services for all the request messages (701), the receiver may transmit, to the originator, rejection of execution of the services for the request messages as a response message. In this case, it is possible to reduce a time required to process unnecessary request messages. That is, since the hosting common service entity (CSE) of the receiver does not need to deliver the request messages to an application, time efficiency may be achieved. In addition, since the hosting CSE generally has more processing functions than the application, it is easy to detect a conflict between the request messages.

As another embodiment, when the receiver executes the all requested services for all the request messages (702) or executes the requested services for the selected request messages (703), it is necessary to determine timing of service execution, that is, the order of execution, at a common service function level or an application level. In this case, the order of execution may be determined by one or both of priority of the request messages and frequent usage of the request messages. In this case, the receiver may transmit execution of the services for the request messages or rejection of the execution of the services for the request messages as a response message. In this case, since the hosting CSE of the receiver determines a request to be executed according to the message handling policy without identifying whether one or more request messages are in conflict, it is possible to deliver all the request messages to the application without any change. Therefore, it is possible to save more time.

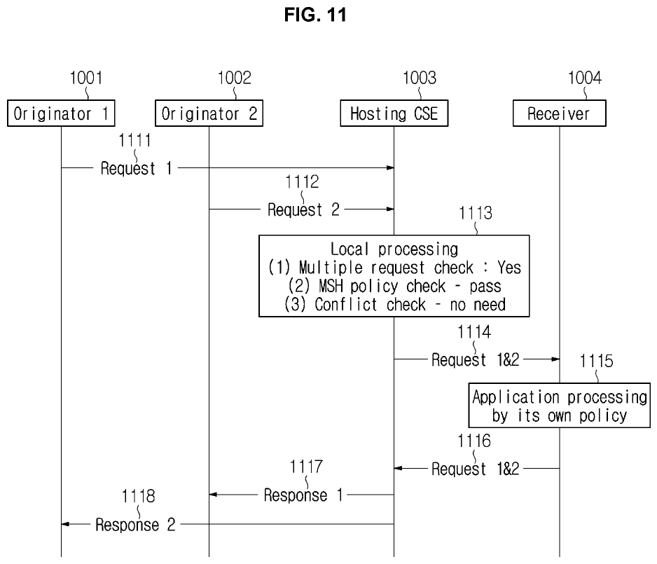

FIG. 9 is a view showing resources and attributes related to a message handling policy in an M2M system according to the present disclosure.

As an embodiment, the message handling policy may be defined at the CSF level and may be defined as the attributes of resource <CSEBase>.

As an embodiment, a newly defined attribute <messageHandlingPolicy> may specifies a rule which is applied when a CSE receives incompatible messages at the same time or within a predefined short period of time, that is, a message handling policy. As an embodiment, the attribute <messageHandlingPolicy> may indicate “doNothing” when execution of the services for all the request messages is rejected and may indicate “Pass” when the services for all the request messages are executed. When the requested services for the selected request messages are executed, another value may be indicated.

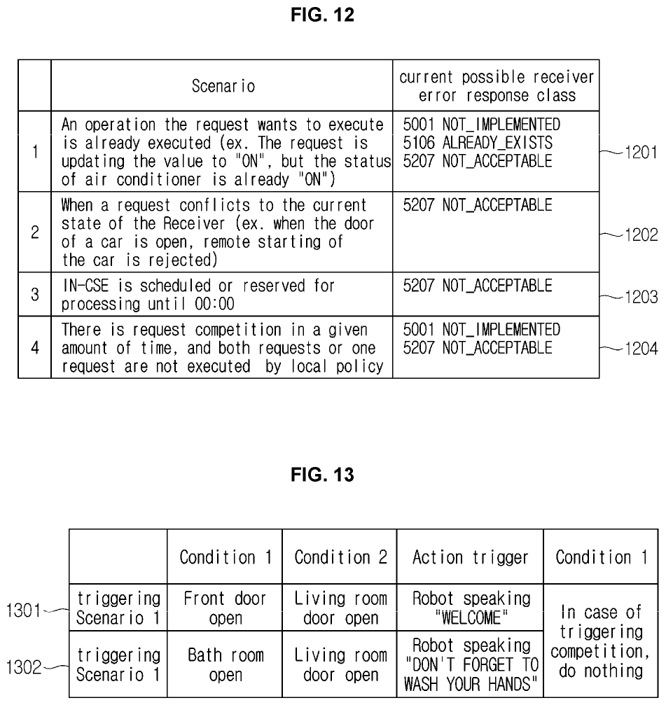

FIGS. 10 and 11 are views showing a message handling order for each subject in an M2M system according to the present disclosure.

As an embodiment, an M2M system may include one or more originators (Originators 1 and 2) 1001 and 1002, a hosting CSE 1003, and a receiver 1004. Meanwhile, although the hosting CSE and the receiver are shown as being separated from each other for clarity, the hosting CSE may be included in the receiver.

Originator 1 1001 and Originator 2 1002 may transmit first request messages 1011 and 1111 and second request messages 1012 and 1112 to the receiver 1004. Although the first request messages 1011 and 1111 are shown as being transmitted temporally earlier than the second request messages 1012 and 1112 in FIGS. 10 and 11, this is merely an embodiment and the second request messages may be transmitted temporally earlier or the first request messages and the second request messages may be simultaneously transmitted.

According to the embodiments of FIGS. 10 and 11, the first request message 1011 and the second request message 1012 transmitted within a predefined period of time or at the same time may be received by the hosting CSE 1003 of the receiver 1004. The hosting CSE 1003 may perform local processing, that is, message processing, with respect to the received message. Local processing 1013 may include determining whether a plurality of request messages has been received, determining what a message handling policy is, and determining whether a plurality of request messages is in conflict.

However, FIGS. 10 and 11 show embodiments of the case where a plurality of request messages is in conflict with each other, that is, a plurality of incompatible request messages is received, which may include a process of determining whether the plurality of request messages is in conflict, that is, whether there are incompatible request messages during local processing. However, as described above, in the case of an incompatible request message requiring an incorrect service execution condition, a process of determining whether the service execution condition is appropriate may be included in local processing. When the incompatible request message is in conflict with the current state of the receiver, a process of determining whether there is a conflict with the current state may be included in local processing. That is, local processing may be differently performed according to the type of the incompatible request message, without being limited to the above-described examples. The message handling policy may be defined at the common service function level as described above.

According to the embodiment of FIG. 10, the hosting CSE 1003 may process the received request messages according to the message handling policy, when the plurality of request messages 1011 and 1012 is received (Multiple request check: yes) and it is determined that the first and second request messages 1011 and 1012 are in conflict with each other (Conflict check: incompatible Yes). For example, when the message handling policy is set to reject execution of the services for all the request messages (MSH policy check: do nothing), the attribute <messageHandlingPolicy> of the resource <CSEBase> may be set to “doNothing”. In this case, the hosting CSE may not deliver the request messages to the receiver 1005 and may immediately transmit Response Messages 1 and 2 1014 and 1015 to the originators 1001 and 1002. In this case, the response messages may be respectively transmitted in response to the request messages and may include a response status code (RSC) indicating that an error has occurred. That is, the response status code may be determined based on the message handling policy. The hosting CSE may not deliver the request messages to the receiver 1005, and may immediately transmit Response Messages 1 and 2 1014 and 1015 to the originators 1001 and 1002. The response messages may be respectively transmitted in response to the request messages and may include a response status code (RSC) indicating that an error has occurred. An example of a general response status code related to the originator of oneM2M to indicate the type of the error is shown in Table 7 below.

TABLE 7

| Code | Description |
|---|---|
| 4000 | BAD_REQUEST |
| 4001 | RELEASE_VERSION_NOT_SUPPORTED |
| 4004 | NOT_FOUND |
| 4005 | OPERATION_NOT_ALLOWED |
| 4008 | REQUEST_TIMEOUT |
| 4015 | UNSUPPORTED_MEDIA_TYPE |
| 4101 | SUBSCRIPTION_CREATOR_HAS_NO_PRIVILEGE |
| 4102 | CONTENTS_UNACCEPTABLE |
| 4103 | ORIGINATOR_HAS_NO_PRIVILEGE |
| 4104 | GROUP_REQUEST_IDENTIFIER_EXISTS |
| 4105 | CONFLICT |
| 4106 | ORIGINATOR_HAS_NOT_REGISTERED |
| 4107 | SECURITY_ASSOCIATION_REQUIRED |
| 4108 | INVALID_CHILD_RESOURCE_TYPE |
| 4109 | NO_MEMBERS |
| 4110 | GROUP_MEMBER_TYPE_INCONSISTENT |
| 4111 | ESPRIM_UNSUPPORTED_OPTION |
| 4103 | ORIGINATOR_HAS_NO_PRIVILEGE |
| 4104 | GROUP_REQUEST_IDENTIFIER_EXISTS |
| 4105 | CONFLICT |
| 4106 | ORIGINATOR_HAS_NOT_REGISTERED |
| 4107 | SECURITY_ASSOCIATION_REQUIRED |
| 4108 | INVALID_CHILD_RESOURCE_TYPE |
| 4109 | NO_MEMBERS |
| 4110 | GROUP_MEMBER_TYPE_INCONSISTENT |
| 4111 | ESPRIM_UNSUPPORTED_OPTION |

An example of a general response status code related to receiver is shown in Table 8 below.

TABLE 8

| Code | Description |
|---|---|
| 5000 | INTERNAL_SERVER_ERROR |
| 5001 | NOT_IMPLEMENTED |
| 5103 | TARGET_NOT_REACHABLE |
| 5105 | RECEIVER_HAS_NO_PRIVILEGE |
| 5106 | ALREADY_EXISTS |
| 5203 | TARGET_NOT_SUBSCRIBABLE |
| 5204 | SUBSCRIPTION_VERIFICATION_INITIATION_FAILED |
| 5205 | SUBSCRIPTION_HOST_HAS_NO_PRIVILEGE |
| 5206 | NON_BLOCKING_REQUEST_NOT_SUPPORTED |
| 5207 | NOT_ACCEPTABLE |
| 5208 | DISCOVERY_DENIED_BY_IPE |
| 5209 | GROUP_MEMBERS_NOT_RESPONDED |
| 5210 | ESPRIM_DECRYPTION_ERROR |
| 5211 | ESPRIM_ENCRYPTION_ERROR |
| 5212 | SPARQL_UPDATE_ERROR |
| 5214 | TARGET_HAS_NO_SESSION_CAPABILITY |
| 5215 | SESSION_IS_ONLINE |
| 5216 | JOIN_MULTICAST_GROUP_FAILED |
| 5217 | LEAVE_MULTICAST_GROUP_FAILED |
| 5218 | TRIGGERING_DISABLED_FOR_RECIPIENT |
| 5219 | UNABLE_TO_REPLACE_TRIGGER_REQUEST |
| 5220 | UNABLE_TO_RECALL_TRIGGER_REQUEST |
| 5221 | CROSS_RESOURCE_OPERATION_FAILURE |

The response status code may be used to inform the originator and/or the receiver of why the services for the request messages are not executed from the viewpoint of the originator and/or the receiver. That is, the response status code may include an error code and the originator may determine what action is taken based on the error code. For example, the originator may retransmit the request message thereof after knowing that an error has occurred in the request message thereof. Retransmission may be performed after an appropriate period of time.

Meanwhile, according to the embodiment of FIG. 11, for example, when the message handling policy is set to execute the services for all the request messages, the attribute <messageHandlingPolicy> of the resource <CSEBase> may be set to “Pass” (MSH policy check: pass). In this case, even if the plurality of request messages 1111 and 1112 is received (Multiple request check: yes), the hosting CSE 1003 may transmit all the request messages 114 to the receiver 1004 without determining whether the first and second request messages 1111 and 1112 are in conflict (conflict check: no need). The receiver 1004, which has received them (114), process all the request messages at the application level according to the policy of the receiver (1115). Thereafter, the receiver may transmit Response Messages 1 and 2 1116 including the result of processing to the hosting CSE 1003 in response to the request messages. Response Message 1 may be transmitted to Originator 1 1001, which has transmitted the first request message, and Response Message 2 may be transmitted to Originator 2 1002, which has transmitted the second request message.

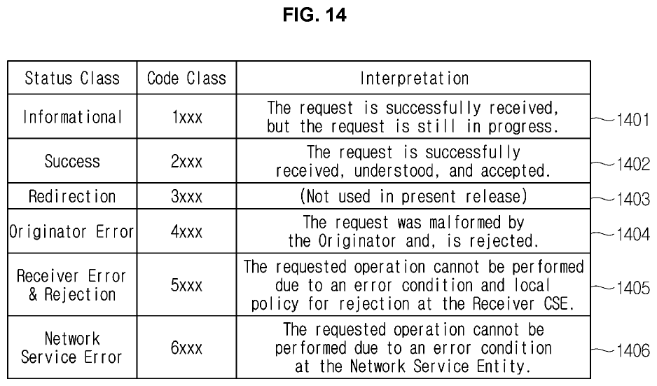

FIG. 12 is a view showing a scenario in which message handling is required in an M2M system according to the present disclosure. More specifically, a scenario in which a request message is successfully transmitted in the M2M system but message handling needs to be performed after the message is received by the hosting CSE and a response status code which may be included in the response message corresponding to the request message are shown.

As an embodiment, a case 1201 where the service indicated by the request message does not need to be executed may occur. In this case, the request message may be expressed as an incompatible request message. That is, a case where the current state of the receiver already satisfies the service indicated by the request message may occur. For example, the request message may request to turn on an air conditioner, but the air conditioner may be already turned on. In this case, a possible response status code may appear as an error response class including this. The error response class may include, for example, 5001 NOT_IMPLEMENTED, 5106 ALREADY_EXISTS and 5207 NOT_ACCEPTABLE. In addition, this may be determined based on the message handling policy.

As another embodiment, a case 1202 where the service indicated by the request message is in conflict with the current state of the receiver may also occur. For example, the request message may request to unlock a door of a moving object such as a vehicle, but this may be determined as a valid request message only when the originator of the request message is located within a certain distance from the moving object. That is, when the originator is out of the certain distance from the moving object, even if the request message is received, the service cannot be normally executed. When the request message is received outside the certain distance, the error response class may include, for example, 5207 NOT_ACCEPTABLE (response status code).

As another embodiment, a case 1203 where the execution condition of the service indicated by the request message is incorrect may also occur. In this case, the request message may be expressed as an incompatible request message. For example, the request message requests operation requiring processing of IN-CSE and a service related thereto, the duration of which may be indicated as 00:00. In this case, the error response class may include, for example, 5207 NOT_ACCEPTABLE.

As another embodiment, a case 1204 where a plurality of incompatible request messages received within a predefined period of time or at the same time is in conflict with each other may occur. In this case, the request message may be expressed as an incompatible request message. This may correspond to the embodiment described with reference to FIG. 10, and the requested services may be executed with respect to some or all of the request messages according to the message handling policy. In this case, the error response class may include, for example, 5001 NOT_IMPLEMENTED and 5207 NOT_ACCEPTABLE.

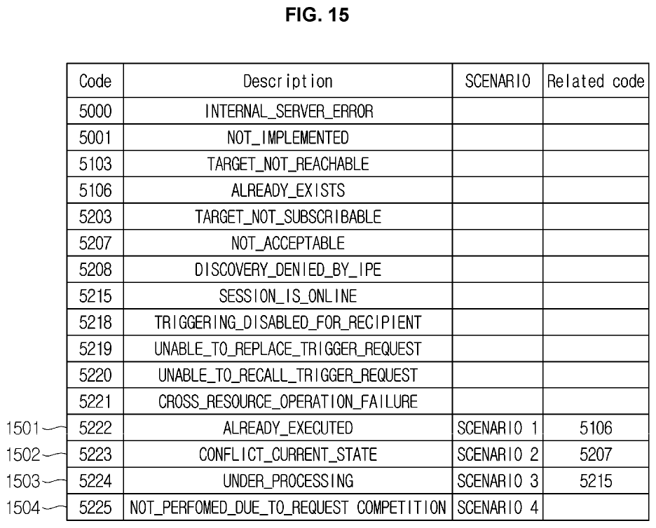

Meanwhile, according to the above-described embodiments, it can be seen that one response status code is not used only in one specific case, but may be used multiple times in various scenarios. In this case, from the viewpoint of the originator which receives the response message including the response status code, a reason for rejecting execution of the service is not specified and thus another problem may occur. This will be described in greater detail with reference to FIG. 13. Another example of a response status code for solving this will be described in greater detail with reference to FIGS. 14 to 15.

FIG. 13 is a view showing a scenario in which message handling is required in an M2M system according to the present disclosure. More specifically, as an embodiment, a case where a plurality of request messages is successfully received, but a temporal conflict between the request messages occurs and thus execution of the request service is rejected by the message handling policy is shown. In this case, as described above, the receiver may transmit a response message including a response status code.

First, action triggering resource may be generated, and a message handling policy for handling a conflict of action triggering by the request messages received from a plurality of originators, that is, a conflict between request services, may be generated. For example, the message handling policy (doNothing) for disabling all the request services from be executed may be generated.

Thereafter, a plurality of request messages may be successfully received and a conflict between the request messages may occur. For example, a first request message 1301 may request to open a front door and to open a living room door. According to this request, a robot may be triggered to audibly output a sentence “Welcome”. Meanwhile, a second request message 1302 may request to open a bathroom door and to open a living room door. According to this request, the robot may be triggered to audibly output a sentence “Don't forget to wash your hands”. When the first and second request messages are received at the same time or within the predefined period of time, the robot cannot audibly output the two sentences at the same time. Therefore, a conflict may occur. In this case, none of the request services indicated by the plurality of received request messages may be executed according to the message handling policy, and an IN-CSE may transmit a response message including 5001 NOT_IMPLEMENTED response status code (RSC) in response to each request message.

As an embodiment, the originator may receive the response message and determine which error has occurred through the response status code. However, as described above, since the same response status code is used in different situations, a problem may occur. Therefore, the originator may not determine an accurate reason for the error and may retransmit the same request message. As described above, if a retransmission process is performed when execution of the request service is rejected due to the conflict between the plurality of request messages, another originator may retransmit the same request message as before and thus a conflict between the request messages may occur again. In this case, a situation having a larger error may occur and a process of retransmitting the request message may be inefficient. Therefore, it may be important that the reason for rejection of execution of the service is indicated as much as detailed as possible. A response status code defined for this will be described in greater detail with reference to FIGS. 14 and 15.

FIG. 14 is a view showing a response status code for an incompatible request message in an M2M system according to the present disclosure. More specifically, FIG. 14 is a view illustrating a response status code newly defined based on a response status code class defined in oneM2M as an embodiment.

As an embodiment, a response status code may be defined by reflecting a service execution rejection case according to the message handling policy based on the response status code class (error response class) defined by oneM2M.

According to the response status code class defined by oneM2M, as an embodiment, when a code class is 1xxx, the status class may mean Informational (1401), which may mean that the request message is successfully received but the request service is still in progress.

As another embodiment, when the code class is 2xxx, the status class may mean Success (1402), which means that the request message is successfully received, accepted, and appropriately processed by the receiver.

As another embodiment, when the code class is 3xxx, the status class may mean Redirection (1403). Meanwhile, the code class is not currently used in most M2M systems.

As another embodiment, when the code class is 4xxx, the status class may mean Originator Error (1404). This may mean that the request message was incorrectly transmitted due to an error of the originator and was incorrectly configured and thus are rejected by the receiver.

As another embodiment, when the code class is 5xxx, the status class may mean Receiver Error and Rejection (1405). This may mean that an error has occurred and the request service for the request message cannot be performed due to an error condition based on the message handling policy at the CSE of the receiver.

As another embodiment, when the code class is 6xxx, the status class may mean Network Service Error (1406). This may mean the request service indicated by the request message cannot be performed due to an error condition at the network service entity.

Meanwhile, the status class name and the code class number are merely an embodiment and thus are not limited thereto.

FIG. 15 is a view showing a response status code corresponding to a request message in an M2M system according to the present disclosure. More specifically, a view showing a new response status code which may be included in a receiver error and rejection status class which is a newly defined code class 5xxx is shown.

As an embodiment, the code class 5xxx may include all existing response status codes. For example, 5000 INTERNAL_SERVER_ERROR, 5001 NOT_IMPLEMENTED, 5103 TARGET_NOT_REACHABLE, 5106 ALREADY_EXISTS, 5203 TARGET_NOT_SUBSCRIBABLE, 5207 NOT_ACCEPTABLE, 5208 DISCOVERY_DENIED_BY_IPE, 5215 SESSION_IS_ONLINE, 5218 TRIGGERING_DISABLED_FOR_RECIPIENT, 5219 UNABLE_TO_REPLACE_TRIGGER_REQUEST, 5220 UNABLE_TO_RECALL_TRIGGER_REQUEST, and 5221 CROSS_RESOURCE_OPERATION_FAILURE may be included.

Meanwhile, as an embodiment, a newly defined response status code 5222 ALREADY_EXECUTED 1501 is applicable when the request service indicated by the request message does not need to be executed. For example, this is applicable to the scenario 1201 of FIG. 12. This may be associated with the existing response status code 5106 ALREADY_EXISTS.

In addition, a newly defined response status code 5223 CONFLICT_CURRENT_STATE 1502 is applicable when the service indicated by the request message is in conflict with the current state of the receiver. For example, this is applicable to the scenario 1202 of FIG. 12. This may be associated with the existing response status code 5207 NOT_ACCEPTABLE.

In addition, a newly defined response status code 5224 UNDER_PROCESSING 1503 is applicable when the execution condition of the service indicated by the request message is incorrect. For example, this is applicable to the scenario 1203 of FIG. 12. This may be associated with the existing response status code 5215 SESSION_IS_ONLINE.

In addition, a newly defined response status code 5225 NOT_PERFORMED_DUE_TO_REQUEST_COMPETITION 1504 is applicable when a plurality of request messages received within a predefined period of time is in conflict with each other. For example, this is applicable to the scenario 1204 of FIG. 12.

Meanwhile, the names and numbers of the newly defined response status codes are merely illustrative and are not limited thereto.

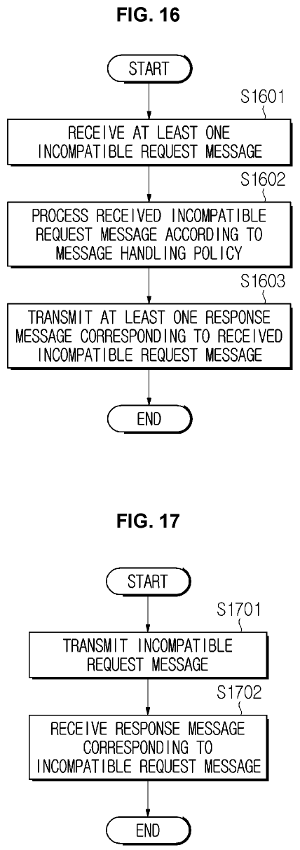

FIGS. 16 and 17 are views illustrating a message handling method in an M2M system according to the present disclosure. More specifically, FIG. 16 is a view illustrating the message handling method based on a receiver, and FIG. 17 is a view illustrating the message handling method based on an originator. The originator may perform request message transmission and response message reception operation, and the receiver may perform operation of receiving a request message, handling the request message according to the message handling policy and transmitting a response message. Here, the receiver may be used to include both the hosting CSE and the receiver of FIGS. 10 to 11.

The originator and the receiver are merely classified according to the role and operation thereof and thus may be an M2M entity including an M2M apparatus of an M2M system. There may be a plurality of originators and receivers. In addition, it may be implemented in software and is not limited to a specific configuration method.

As an embodiment, the originator may transmit a request message to the receiver (S1701). The request message may include content for requesting a certain service and may trigger specific operation. At least one originator may transmit the request message to the same receiver or another receiver (S1701) or one originator may transmit multiple request messages. As described above, the request message may be an incompatible request message which is incompatible with the request message transmitted by another originator or an incompatible request message which is in conflict with the current state of the M2M apparatus for transmitting the request message, does not require execution or has an incorrect execution condition. The receiver may receive the incompatible request message from the originator (S1601). Since request messages may be received from a plurality of originators, at least one request message may be received. Thereafter, the receiver may process the received incompatible request message according to the message handling policy (S1602). At this time, the message handling policy may be the same as described above. That is, the message handling policy may be defined at the common service function level and may be defined as the attribute of the resource <CSEBase>. The message handling policy may be predetermined before the request message is received or after the request message is received. According to the message handling policy, all or some of services requested by at least one request message may be executed or none of them may be executed, as described above. Meanwhile, when all or some of the requested services are executed, the order of execution may be determined and may be determined based on the priority or frequent usage of the request messages as described above. In addition, the received at least one request message may have an incorrect request service execution condition, the receiver may not need to execute the request service, the service cannot be executed due to a conflict with the current state of the receiver or a conflict may occur due to reception of the request messages at the same time or within a predefined period of time. In order to distinguish such cases, the receiver may perform local processing such as determining whether at least one request message has been received, checking the message handling policy, determining whether a conflict between messages has occurred when a plurality of request messages is received, which may be included in this process S1602. Meanwhile, the local processing may vary according to the received request message, as described above.

Thereafter, the receiver may transmit at least one response message corresponding to the received incompatible request message (S1603). The response message may be individually transmitted to the originator which has transmitted the request message, and may include a response status code (RSC). The response status code may be used to indicate a detailed reason why the service has been rejected when service execution has been rejected. That is, the response status code may be based on the message handling policy. This may be the same as described above with reference to FIGS. 12 to 15.

The originator may receive the response message corresponding to the incompatible request message (S1702). Since the response message may include the response status code determined based on the message handling policy, the originator may determine whether the incompatible request message thereof has been appropriately processed by the receiver. When the request service indicated by the request message transmitted by the originator is not executed, the originator may select appropriate countermeasures. For example, the already transmitted request message may be retransmitted after a certain period of time or after the position or state of the originator is changed, which may vary according to the type of the received response status code.

Since the above-described operations of the originator and the receiver are merely illustrative, the order thereof may be changed, some operations may be added or, if necessary, some operations may not be performed.

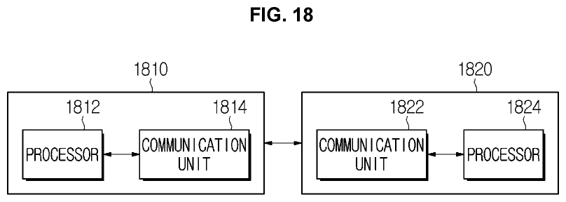

FIG. 18 is a view illustrating a configuration of M2M devices in an M2M system according to the present disclosure.

Referring to FIG. 18, the M2M device 1810 may include the processor 1812 configured to operate a device and the communication unit 1814 configured to transmit and receive a signal. In particular, the processor 1812 may be configured to operate the communication unit 1814. In addition, the M2M device 1810 may be configured to perform a communication with another M2M device 1820. The other or second M2M device 1820 may also include the processor 1824 and the communication unit 1822, and the processor 1824 and the communication unit 1822 may be configured to perform the same function as the processor 1812 and the communication unit 1814 of the first M2M device 1810.

In one exemplary embodiment, the communication unit 1814, 1822 may be a transmitter, or a receiver, or a transceiver, or a communication module and used interchangeably with a communication unit. For example, the originator and the receiver, which are described above, may be one of the M2M devices 1810 and 1820 of FIG. 18, respectively. In addition, the devices 1810 and 1820 of FIG. 18 may be different devices. For example, the devices 1810 and 1820 of FIG. 18 may be communication devices, apparatuses, terminals, vehicles, or base stations in M2M system. In other words, the devices 1810 and 1820 of FIG. 18 refer to devices, configured to perform a communication, and are not limited to the above-described exemplary embodiments.

Effects obtained in the present disclosure are not limited to the above-mentioned effect, and other effects not mentioned above may be clearly understood by those skilled in the art from the following description.

In the exemplary system described above, processes are described as a series of steps or blocks based on a flowchart, aspects of the present disclosure are not limited to the illustrated order or sequence. Some steps may be processed in a different order or may be processed substantially simultaneously. Further, it will be understood that the illustrated steps in a flowchart do not necessarily exclude other steps, other steps may be included and one or more steps in a flowchart may be omitted without departing from the spirit and scope of the present disclosure.

The above description is to explain the technical aspects of exemplary embodiments of the present disclosure, and it will be apparent to those skills in the art that modifications and variations can be made without departing from the spirit and scope of the present disclosure. Thus, it is intended that the present disclosure cover the modifications and variations of this disclosure provided they come within the scope of the appended claims and their equivalents.

The above-described exemplary embodiments of the present disclosure may be implemented by various means. For example, the exemplary embodiments of the present disclosure may be implemented by hardware, firmware, software, non-transitory computer-readable medium on which a software or command is stored and executable on a device or a computer, or a combination thereof.

The processors may include an application-specific integrated circuit (ASIC), another chipset, a logic circuit, and/or a data processing device. The memories may include a Read-Only Memory (ROM), a Random Access Memory (RAM), a flash memory, a memory card, a storage medium and/or another storage device. The RF units may include a baseband circuit for processing a wireless signal. When an exemplary embodiment is embodied as software, the described scheme may be embodied as a module (process, function, or the like) that executes the described function. The module may be stored in a memory, and may be executed by a processor. The memory may be disposed inside or outside the processor, and may be connected to the processor through various well-known means.

In the described exemplary system, although methods are described based on a flowchart as a series of steps or blocks, aspects of the present disclosure are not limited to the sequence of the steps and a step may be executed in a different order or may be executed in parallel with another step. In addition, it is apparent to those skilled in the art that the steps in the flowchart are not exclusive, and another step may be included or one or more steps of the flowchart may be omitted without affecting the scope of the present disclosure.

What is claimed is:

1. A message handling method performed by a machine-to-machine (M2M) apparatus in an M2M system, the message handling method comprising:
receiving at least one incompatible request message;
processing the incompatible request message according to a message handling policy; and
transmitting at least one response message corresponding to the incompatible request message.

2. The message handling method of claim 1, wherein when a plurality of incompatible request messages which are in conflict with each other is received, the message handling policy indicates rejection of services for all the plurality of incompatible request messages.

3. The message handling method of claim 2, wherein the plurality of incompatible request messages is received within a preset time or at the same time.

4. The message handling method of claim 2, wherein the response message includes a response status code indicating that a service has been rejected due to a conflict with another request message.

5. The message handling method of claim 1, wherein when a plurality of incompatible request messages which are in conflict with each other is received, the message handling policy indicates execution of services for all or some of the plurality of incompatible request messages.

6. The message handling method of claim 5, wherein when the services for all or some of the plurality of incompatible request messages are executed, the services are executed in the order of execution determined according to the message handling policy.

7. The message handling method of claim 6, wherein the order of execution order is determined based on at least one of priority or frequent usage of the plurality of incompatible request messages.

8. The message handling method of claim 1, wherein when the at least one incompatible request message is in conflict with a current state of the M2M apparatus, the message handling policy indicates rejection of a service requested by the at least one incompatible request message.

9. The message handling method of claim 8, wherein the response message corresponds to the incompatible request message, and includes a response status code indicating that a requested service has been rejected because the requested service cannot be provided based on the current state.

10. The message handling method of claim 1, wherein when the at least one incompatible request message requests the same service as a current state of the M2M apparatus, the message handling policy indicates rejection of a service for the request message.

11. The message handling method of claim 10, wherein the response message corresponds to the incompatible request message, and includes a response status code indicating that a service has been rejected because there is no service to be executed in the current state.

12. The message handling method of claim 1, wherein, when the at least one incompatible request message is based on an incorrect service condition, the message handling policy indicates rejection of a service for the incompatible request message.

13. The message handling method of claim 12, wherein the response message corresponds to the incompatible request message, and includes a response status code indicating that a service has been rejected due to the incorrect service condition.

14. The message handling method of claim 1, wherein the message handling policy is defined at a common service function level.

15. The message handling method of claim 1, wherein the message handling policy is defined as an attribute of resource <CSEBase>.

16. A machine-to-machine (M2M) apparatus in an M2M system, comprising:
a communication unit configured to transmit and receive a signal; and
a processor configured to control the communication unit,
wherein the processor is configured to:
process a received incompatible request message according to a message handling policy; and
transmit at least one response message corresponding to the incompatible request message.

17. The M2M apparatus of claim 16, wherein the message handling policy is defined as an attribute of resource <CSEBase>.

18. The M2M apparatus of claim 16, wherein the message handling policy is defined at a common service function level.

19. A machine-to-machine (M2M) apparatus in an M2M system, comprising:
a communication unit configured to transmit and receive a signal; and
a processor configured to control the communication unit,
wherein the processor is configured to:
generate an incompatible request message to be transmitted to another M2M apparatus, and
check a response status code of a response message received from the other M2M apparatus and corresponding to the incompatible request message, and
wherein the response status code is determined based on a message handling policy of the other M2M apparatus.

20. The M2M apparatus of claim 19, wherein the message handling policy is defined at a common service function level.
